(19) United States
(12) Patent Application Publication
(10) Pub. No.: US 2014/0259055 A1
(43) Pub. Date: Sep. 11, 2014

(54) SYSTEMS AND METHODS FOR A NON-INTRUSIVE VIDEO ADVERTISEMENT WALL

(71) Applicant: YAHOO! INC., Sunnyvale, CA (US)

(72) Inventor: Puneet Mohan Sangal, Bangalore (IN)

(73) Assignee: YAHOO! INC., Sunnyvale, CA (US)

(21) Appl. No.: 13/786,729

(22) Filed: Mar. 6, 2013

(51) Int. Cl. H04N 21/81

(52) U.S. Cl. CPC H04N 21/812
USPC 725/34

(57) ABSTRACT

Techniques are provided which enhance a user's experience by creating non-intrusive advertising schemes enabling the user to pursue targeted advertisements and/or discounts at a convenient time. During presentation of an online video, the user may “park” an advertisement for later viewing, permitting the focus to remain on the online video content and not on the advertisements. The “parked” advertisement is displayed as an icon adjacent to or minimally overlapping the video. Once the user selects the icon, the corresponding advertisement is displayed in the browser or the player. If the original video is being displayed when the user selects an icon, the video will pause and resume once the advertisement is displayed to completion or closed by the viewer.

### BACKGROUND

Conventionally, targeted advertisements have focused primarily on determining relevant content for a particular user. However, less attention has been given to controlling user interaction with the targeted advertisement itself, an aspect which is as influential, if not more, than what is actually presented. For example, if a user is targeted with an advertisement, there are no means of ensuring the user will properly view or experience the advertising content amidst other content being displayed. This is especially true for advertisements which offer time-sensitive discounts for products deemed relevant to a particular user. Even if the particular user would otherwise have an interest in pursuing the offer, the intrusive nature of the advertisement and inconvenient timing may obscure the intended impact and relevance of a targeted advertisement.

Accordingly, there is a need to enhance a user's experience by creating non-intrusive advertising schemes which enable the user to pursue targeted advertisements and/or discounts at a convenient time.

### SUMMARY

In some embodiments, after showing the advertisement normally inside a browser or a video player, the user has the option to park the advertisement to the side of the browser or the player. One by one, the parked advertisements, represented as icons, form a vertical advertisement wall to the side of the player. This non-intrusive arrangement permits the focus to remain on the original video content and not on the advertisements. Once the user selects an icon, the corresponding advertisement is displayed in the browser or the player. If the original video is being displayed when the user selects an icon, the video will pause and resume once the advertisement is displayed to completion or closed by the viewer.

In some embodiments, during or after the advertisement being displayed in the browser or the player, a discount or an offer for a discount is presented to the user. The user may select the offer to redeem the discount towards a purchase or expenditure advertised. If the user selects the offer, the original video being displayed will pause and resume once the user returns to the browser or player.

### BRIEF DESCRIPTION OF THE DRAWINGS

FIG. 1 is a distributed computer system according to one embodiment of the invention;

FIG. 2 is a flow diagram illustrating a method according to one embodiment of the invention;

FIG. 3 is a flow diagram illustrating a method according to one embodiment of the invention;

FIG. 4 is a block diagram illustrating one embodiment of the invention; and

FIG. 5 is a block diagram illustrating one embodiment of the invention.

### DETAILED DESCRIPTION OF THE DRAWINGS

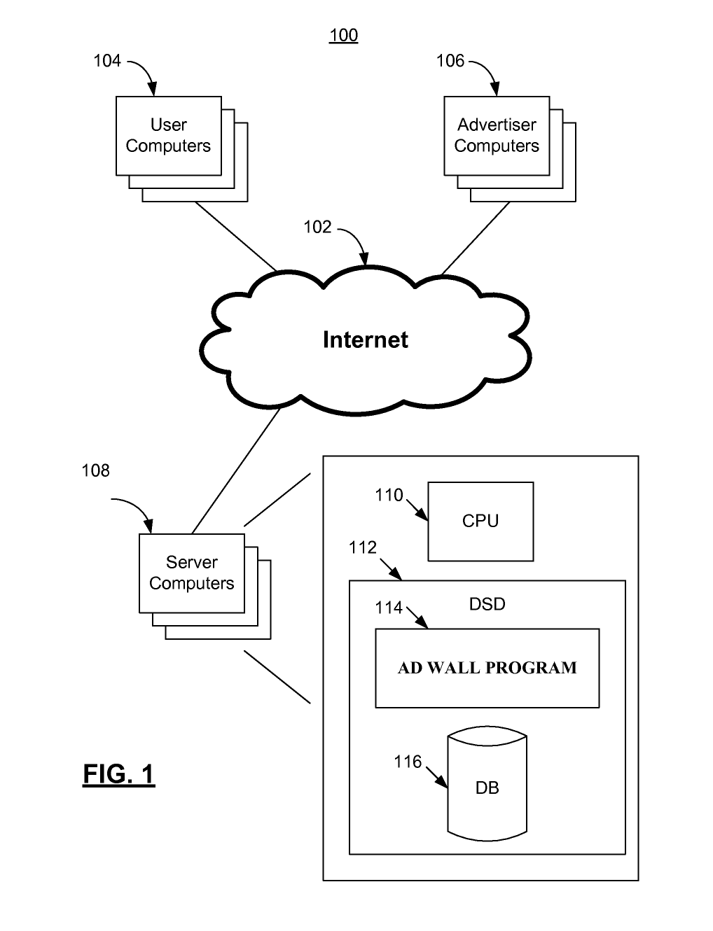

FIG. 1 is a distributed computer system 100 according to one embodiment of the invention. The system 100 includes user computers 104, advertiser computers 106 and server computers 108, all coupled or able to be coupled to the Internet 102. Although the Internet 102 is depicted, the invention contemplates other embodiments in which the Internet is not included, as well as embodiments in which other networks are included in addition to the Internet, including one more wireless networks, WANs, LANs, telephone, cell phone, or other data networks, etc. The invention further contemplates embodiments in which user computers 104 may be or include desktop or laptop PCs, as well as, wireless, mobile, or handheld devices such as smart phones, PDAs, tablets, etc.

Each of the one or more computers 104, 106 and 108 may be distributed, and can include various hardware, software, applications, algorithms, programs and tools. Depicted computers may also include a hard drive, monitor, keyboard, pointing or selecting device, etc. The computers may operate using an operating system such as Windows by Microsoft, etc. Each computer may include a central processing unit (CPU), data storage device, and various amounts of memory including RAM and ROM. Depicted computers may also include various programming, applications, algorithms and software to enable searching, search results, and advertising, such as graphical or banner advertising as well as keyword searching and advertising in a sponsored search context. Many types of advertisements are contemplated, including textual advertisements, rich advertisements, video advertisements, etc.

As depicted, each of the server computers 108 includes one or more CPUs 110 and a data storage device 112. The data storage device 112 includes a database 116 and an Ad Wall Program 114.

The Program 114 is intended to broadly include all programming, applications, algorithms, software and other and tools necessary to implement or facilitate methods and systems according to embodiments of the invention. The elements of the Program 114 may exist on a single server computer or be distributed among multiple computers or devices.

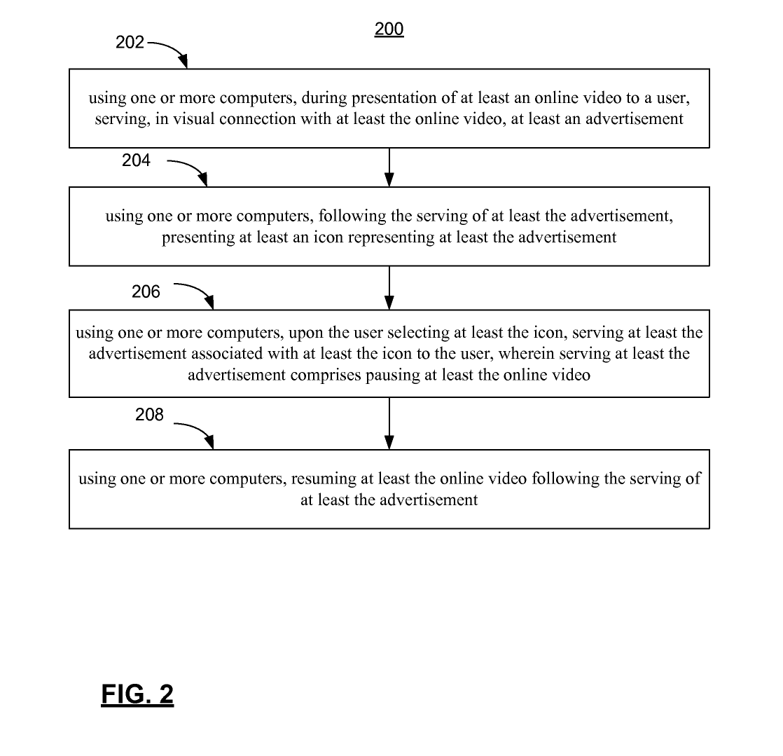

FIG. 2 is a flow diagram illustrating a method 200 according to one embodiment of the invention. At step 202, using one or more server computers, during presentation of at least an online video to a user, at least an advertisement, in visual connection with at least the online video, is served. At step 204, using one or more server computers, following the serving of the advertisement, at least an icon is presented representing at least the advertisement.

At step 206, using one or more server computers, upon the user selecting at least the icon, at least the advertisement associated with at least the icon to the user is served, wherein serving the advertisement comprises pausing the online video. At step 208, using one or more server computers, the online video is resumed following the advertisement being served.

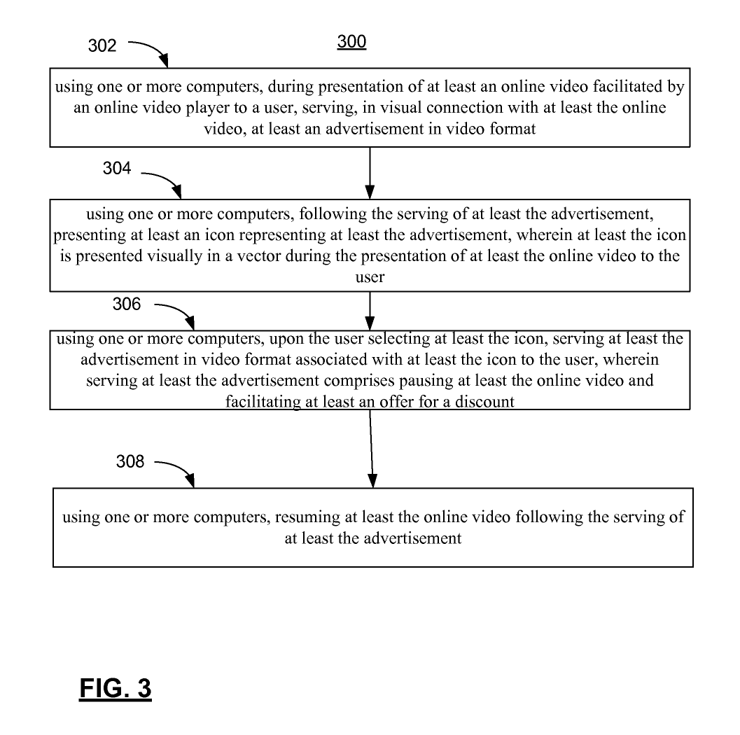

FIG. 3 is a flow diagram illustrating a method 300 according to one embodiment of the invention. At step 302, using one or more server computers, during presentation of at least an online video to a user facilitated by an online video player, at least an advertisement, in visual connection with at least the online video, is served in video format.

At step 304, using one or more server computers, following the serving of the advertisement, at least an icon is presented representing at least the advertisement, wherein the icon is presented visually in a vector during the presentation of the online video to the user.

At step 306, using one or more server computers, upon the user selecting at least the icon, at least the advertisement associated with the icon to the user is served, wherein serving the advertisement comprises pausing the online video and facilitating at least an offer for a discount. At step 308, using one or more server computers, the online video is resumed following the advertisement being served.

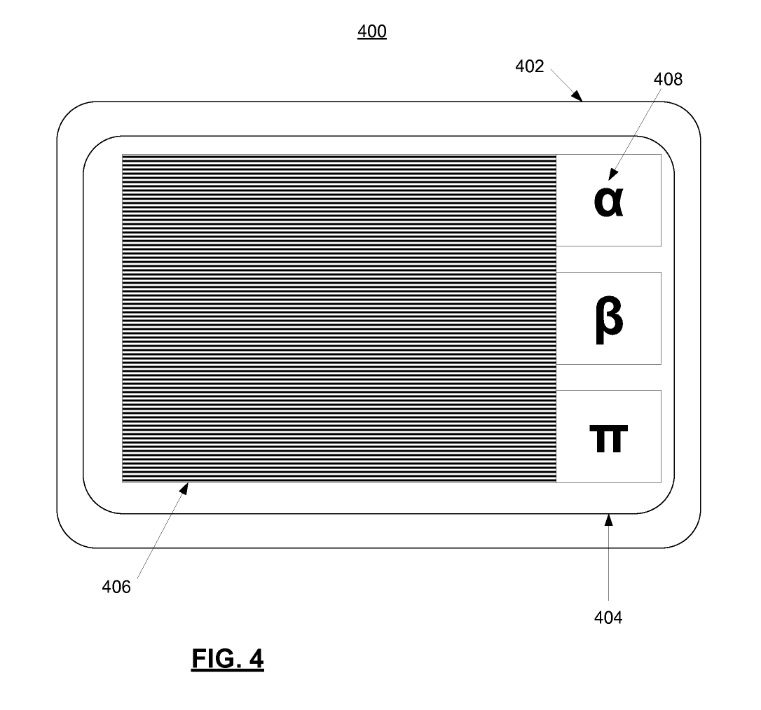

FIG. 4 is a block diagram 400 according to one embodiment of the invention. The handheld device 402 is comprised of a display screen 404 for the user to view content. In one embodiment, an online video is displayed in a browser window 406. The advertisements selected to be parked by the user are situated adjacent to the browser window 406 as icons 408 in a row or column. The user may select the icons 408, which would prompt the advertisement corresponding to the icons 408 to be displayed in the browser window 406. In an alternative embodiment, the online video can be displayed in a video player.

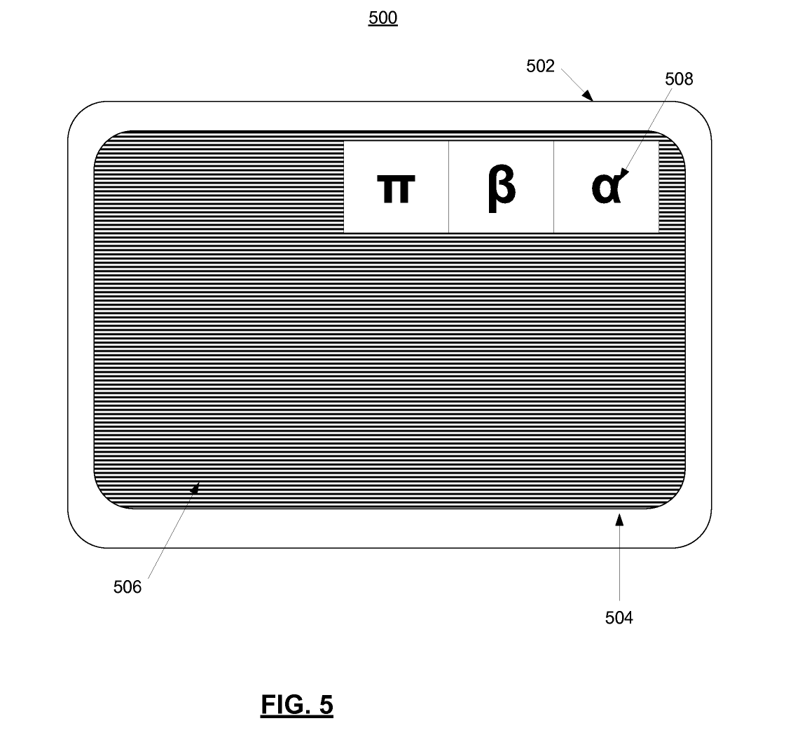

FIG. 5 is a block diagram 500 according to one embodiment of the invention. The handheld device 502 is comprised of a display screen 504 for the user to view content. In one embodiment, an online video is displayed in a full screen video player 506. The advertisements selected to be parked by the user are situated in a non-intrusive position overlapping the full screen video player 506 as icons 508 in a row or column. The user may select the icons 508, which would prompt the advertisement corresponding to the icons 508 to be displayed in the full screen video player 506. In an alternative embodiment, the online video can be displayed in a full screen browser window.

While the invention is described with reference to the above drawings, the drawings are intended to be illustrative, and the invention contemplates other embodiments within the spirit of the invention.

1. A method comprising:
using one or more computers, during presentation of at least an online video to a user, serving, in visual connection with at least the online video, at least an advertisement;
using one or more computers, following the serving of at least the advertisement, presenting at least an icon representing at least the advertisement; and
using one or more computers, upon the user selecting at least the icon, serving at least the advertisement associated with at least the icon to the user.

2. The method of claim 1, wherein at least the icon is presented visually in a vector during the presentation of at least the online video to the user.

3. The method of claim 1, wherein at least the icon is presented visually in a matrix during the presentation of at least the online video to the user.

4. The method of claim 1, wherein at least the icon is presented visually adjacent to at least the online video.

5. The method of claim 1, wherein serving at least the advertisement upon the user selecting at least the icon comprises pausing at least the online video.

6. The method of claim 5, further comprising resuming at least the online video following the serving of at least the advertisement.

7. The method of claim 1, wherein the advertisement is served in video format.

8. The method of claim 1, wherein the advertisement facilitates at least an offer for a discount.

9. The method of claim 1, wherein presentation of at least the online video is facilitated by a video player.

10. A system comprising:
one or more server computers coupled to a network; and
one or more databases coupled to the one or more server computers;
wherein the one or more server computers are for:
during presentation of at least an online video to a user, serving, in visual connection with at least the online video, at least an advertisement;
following the serving of at least the advertisement, presenting at least an icon representing at least the advertisement; and
upon the user selecting at least the icon, serving at least the advertisement associated with at least the icon to the user.

11. The system of claim 10, wherein at least the icon is presented visually in a vector during the presentation of at least the online video to the user.

12. The system of claim 10, wherein at least the icon is presented visually in a matrix during the presentation of at least the online video to the user.

13. The system of claim 10, wherein at least the icon is presented visually adjacent to at least the online video.

14. The system of claim 10, wherein serving at least the advertisement upon the user selecting at least the icon comprises pausing at least the online video.

15. The system of claim 14, further comprising resuming at least the online video following the serving of at least the advertisement.

16. The system of claim 10, wherein the advertisement is served in video format.

17. The system of claim 10, wherein the advertisement facilitates at least an offer for a discount.

18. The system of claim 10, wherein presentation of at least the online video is facilitated by a video player.

19. The system of claim 10, wherein presentation of at least the online video is facilitated by a hand held device.

20. A non-transitory computer readable storage medium having stored thereon instructions for causing a computer to execute a method, the method comprising:
using one or more computers, during presentation of at least an online video to a user, serving, in visual connection with at least the online video, at least an advertisement;
using one or more computers, following the serving of at least the advertisement, presenting at least an icon representing at least the advertisement, wherein at least the icon is presented in a vector visually adjacent to at least the online video during the presentation of at least the online video to the user; and
using one or more computers, upon the user selecting at least the icon, serving at least the advertisement associated with at least the icon to the user.
